(19) United States
(12) Patent Application Publication
(10) Pub. No.: US 2002/0136597 A1
(43) Pub. Date: Sep. 26, 2002

(54) Quick coupler device of working machine

(76) Inventors: Hiroyasu Nishikawa, Tokyo (JP); Akitoshi Nishikawa, Tokyo (JP); Meiichi Ono, Tokyo (JP); Toshihiko Funahashi, Tokyo (JP); Takahiro Iwamoto, Tokyo (JP); Toshiyuki Matsumoto, Osaka (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/980,280

(22) PCT Filed: Mar. 15, 2001
(86) PCT No.: PCT/JP01/02040

(30) Foreign Application Priority Data
Apr. 4, 2000 (JP) 2000-102211

(51) Int. Cl. F16D 1/00

(52) U.S. Cl. 403/322.3

(57) ABSTRACT

A quick coupling device for a working machine, in which a working implement is detach- and attachably coupled to a bracket mounted on the working machine by a pair of coupling shafts and a pair of hooks having an engaging groove detachably engaged with the coupling shafts, wherein it is so designed that the hooks are prevented from interfering with the structural member of the working implement provided between the pair of coupling shafts and foreign matters such as earth and sand are prevented from coming into direct contact with the coupling shafts. The pair of hooks are brought close to each other to bring the coupling shafts into engagement with the hooks.

### DESCRIPTION

1. Technical Field

The present invention relates to a quick coupling device for a working machine. More specifically, the invention relates to a quick coupling device which allows to quickly effect a detachable and attachable coupling of a working implement to a working machine.

2. Background Art

A working machine such as a hydraulic shovel is capable of executing a variety of tasks upon replacing the working implement mounted on its arm by a different counterpart. For example, the task is carried out such as excavating earth and sand and loading them upon mounting a bucket, the task is carried out such as quarrying stones or crushing the road surface upon mounting a hydraulic breaker, and the task is carried out such as dismantling a structure upon mounting a crusher. Therefore, if various working implements such as bucket, breaker, crusher and the like are suitably replaced by detaching the one and attaching the other, it is allowed to use a single hydraulic shovel for accomplishing a multiplicity of objects and functions.

Therefore, the working machine of this kind has been provided with a quick coupling device (hereinafter, to be simply referred to as a quick coupler sometimes) for detach- and attachably and quickly coupling the working implement. With reference to a quick coupler as an example of FIG. 7, the quick coupler which is generally designated at 50 has a bracket 54 which is swingably coupled to an end of an arm 52, the bracket 54 having a fixed hook 56 with an engaging groove 56a and a movable hook 58 with an engaging groove 58a, openings of the respective engaging grooves being faced in the opposite direction relative to each other. A swing-operation means 60 for swing-operating the movable hook 58 is coupled between the movable hook 58 and the bracket 54. A working implement 62 is equipped with a pair of coupling shafts 62a and 62b that respectively engage with the engaging groove 56a of the fixed hook 56 and with the engaging groove 58a of the movable hook 58. A swing-operation link 64 is coupled to the bracket 54 to swing-operating the bracket 54 relative to the arm 52.

To couple the working implement 62 to the arm 52 via the quick coupler 50, the movable hook 58 is moved by the swing-operation means 60 toward the fixed hook 56 side to narrow a distance between the engaging groove 58a of the movable hook 58 and the engaging groove 56a of the fixed hook 56. Thereafter, one coupling shaft 62a of the working implement 62 is first brought into engagement with the engaging groove 56a of the fixed hook 56 and, then, the movable hook 58 is moved in a direction to separate away from the fixed hook 56, so that the other coupling shaft 62b is brought into engagement with the engaging groove 58a. To release the engagement, the movable hook 58 is swing-operated by the swing-operation means 60 toward the direction of the fixed hook 56 to disengage the coupling shaft 62b from the engaging groove 58a and to disengage the coupling shaft 62a from the engaging groove 56a.

Thus, the working implement 62 is detach- and attachably and quickly coupled to the arm 52 via the quick coupler 50. If various working implements are equipped with the above-mentioned pair of coupling shafts 62a and 62b, different working implements can be easily and detach- and attachably mounted on the arm 52.

Disclosure of the Invention

However, the conventional quick coupling device of the above-mentioned configuration has problems that must be solved, as described below.

(1) Interference between the movable hook and the working implement:

In coupling the working implement 62 by bringing the movable hook 58 toward the fixed hook 56 side (indicated by a two-dot chain line in FIG. 7), if there is a structural member 63 of the working implement 62, such as a torque tube which is a reinforcing member of the bucket, between the coupling shaft 62a and the coupling shaft 62b of the working implement 62, the movable hook 58 interferes with the structural member 63 and consequently, can not be pulled toward the fixed hook 56 side to a sufficient degree, imposing limitation on the number of the working implements that can be mounted by using the quick coupler 50.

(2) Damage to the coupling shafts of the working implement:

In a state where the working implement 62 is coupled to the working machine via the quick coupler 50, each of opening of the engaging groove 58a of the movable hook 58 and the opening of the engaging groove 56a of the fixed hook 56 face outward of the working implement 62. Therefore, foreign matters such as earth and sand easily come into direct contact with the coupling shafts 62a and 62b and the coupling shafts are subject to be damaged when the working machine is in operation.

The present invention has been accomplished in view of the above-mentioned facts, and its technical subject is to provide a quick coupling device for a working machine, in which a working implement is detach- and attachably coupled to a bracket mounted on the working machine by using a pair of coupling shafts and a pair of hooks having engaging grooves that are detachably engaged with the respective coupling shafts, wherein the quick coupling device is so designed that the hooks do not interfere with the structural member of the working implement provided between the pair of coupling shafts and foreign matters such as earth and sand are prevented from coming into direct contact with the coupling shafts.

As a quick coupling device to solve the above-mentioned technical subject, the present invention provides a quick coupling device for a working machine, in which a working implement is detach- and attachably coupled to a bracket mounted on the working machine by a pair of coupling shafts and a pair of hooks detachably engaged with the respective coupling shafts, wherein the pair of hooks are brought close to each other to bring the hooks into engagement with the coupling shafts.

In the quick coupling device of the present invention, the pair of hooks are brought close to each other, i.e., are moved inward from the outer side of the working implement to bring the hooks into engagement with the coupling shafts, so that the hooks will not interfere with the structural member of the working implement that may exist between the pair of coupling shafts and further, foreign matters such as earth and sand are prevented from coming into direct contact with the coupling shafts from the outer side as a result of the hooks brought into engagement from the outer side.

According to a preferred embodiment, the pair of hooks have respectively an engaging groove formed therein and comprise a fixed hook secured to the bracket and a movable hook swingably mounted on the bracket, the pair of coupling shafts are provided for the working implement, and an extensible and retractible swing-operation means is arranged between the movable hook and the bracket; and each of the engaging grooves has a U-shape in cross section and its opening faces the direction in which the movable hook swings, the movable hook is caused to swing in a direction to approach the fixed hook by the swing-operation means so that the engaging grooves are brought into engagement with the coupling shafts, and the movable hook is caused to swing in a direction to separate away from the fixed hook by the swing-operation means so as to liberate the engagement. The movable hook is mounted on the bracket at its one end, has the engaging groove formed in the other end thereof, and has the swing-operation means rotatably coupled thereto at an intermediate portion thereof.

The pair of hooks is constituted by the movable hook and the fixed hook, and the movable hook is swing-operated by the swing-operation means to detachably hold the pair of coupling shafts between the movable hook and the fixed hook.

According to another embodiment, the movable hook has the engaging groove formed in one end thereof, has the swing-operation means rotatably coupled to the other end thereof, and is mounted on the bracket at the intermediate portion thereof, the bracket being swingably coupled to the working machine, and a swing-operation link for swing-operating the bracket is coupled to the portion of the movable hook, to which the swing-operation means is coupled so as to rotate on the same axis.

A link for swing-operating the bracket is coupled to the movable hook, so that the force of the swing-operation link is added to the force of the swing-operation means that holds the coupling shaft through the movable hook.

### BRIEF DESCRIPTION OF DRAWINGS

FIG. 1 is a side view illustrating an embodiment of a quick coupling device constituted according to the present invention;

FIG. 2 is a front view of when FIG. 1 is viewed from a direction of arrow A-A (no working implement is shown);

FIG. 3 is a perspective view of a working implement;

FIG. 4 is a front view of a bracket as viewed from the direction of arrow A-A in FIG. 1;

FIG. 5 is a front view of a movable hook as viewed from the direction of arrow A-A in FIG. 1;

FIG. 6 is a side view illustrating another embodiment of the quick coupling device constituted according to the present invention; and

FIG. 7 is a sectional view of a conventional quick coupling device.

### BEST MODE FOR PRACTICING THE INVENTION

Preferred embodiments of the quick coupling device for a working machine constituted according to the present invention will now be described in further detail with reference to the accompanying drawings hereinafter.

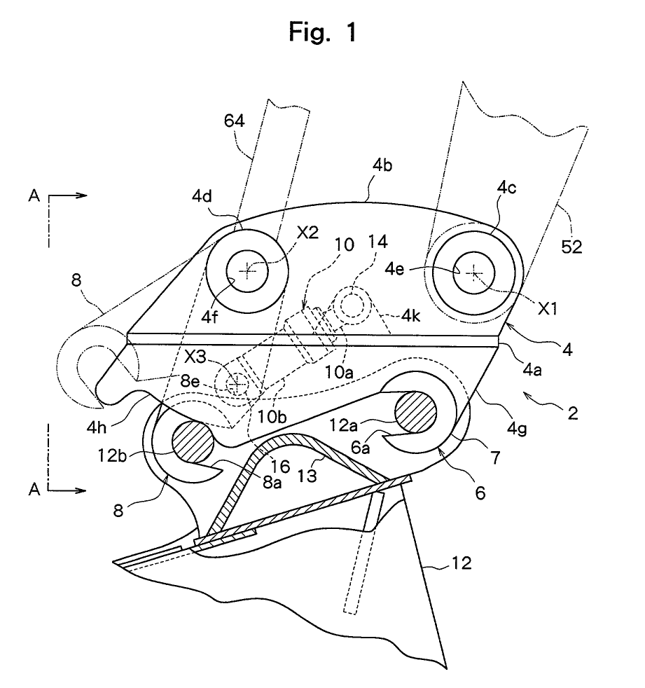

Referring to FIGS. 1 to 3, a quick coupler which is generally designated at 2 comprises a bracket 4 mounted on an end portion of an arm 52 of, for example, a hydraulic shovel which is a working machine so as to pivot on an axis X1, a fixed hook 6 that has an engaging groove 6a formed therein and is secured to the bracket 4, a movable hook 8 that has an engaging groove 8a formed therein and is swingably mounted on the bracket 4, an extensible and retractible swing-operation means 10 disposed between the movable hook 8 and the bracket 4, and a pair of coupling shafts 12a and 12b provided for a bucket 12 as a working implement, the pair of coupling shafts 12a and 12b being detachably engaged with the respective engaging grooves 6a and 8a. An opening of the engaging groove 6a of the fixed hook 6 faces an opening of the engaging groove 8a of the movable hook 8. The bracket 4 is coupled to a swing-operation link 64 for swing-operating the bracket 4 mounted on the arm 52, to rotate about an axis X2.

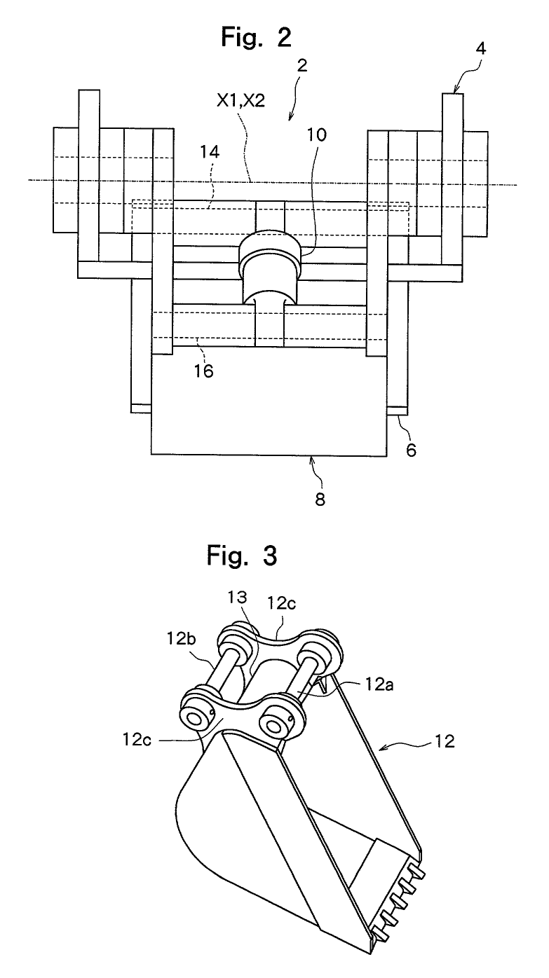

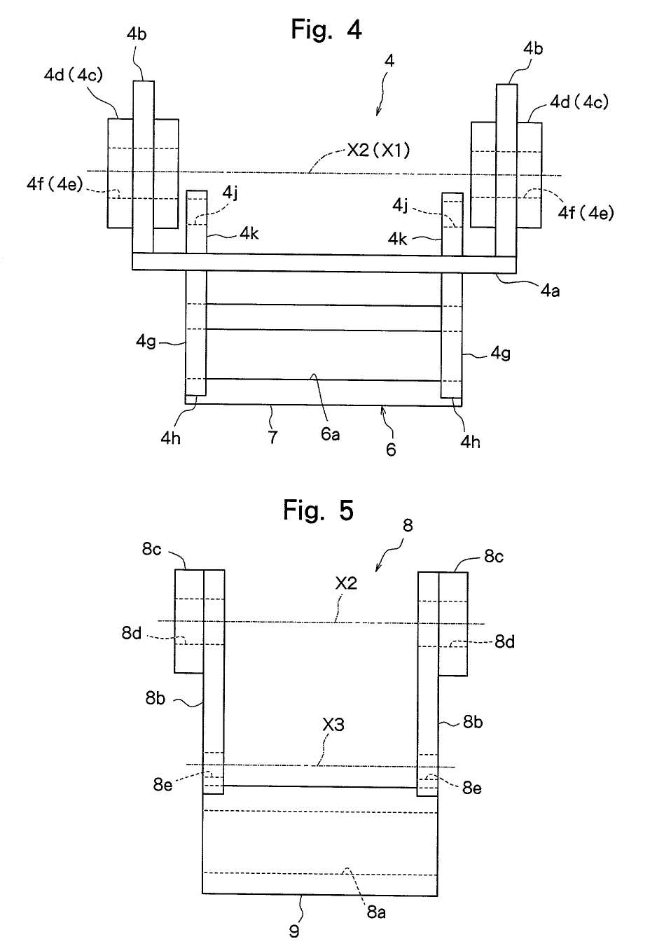

With reference to FIGS. 1 and 2 together with FIG. 4 and chiefly FIG. 4, the bracket 4 is formed as an integrated structure by welding various steel members each other. The bracket 4 has a flat base plate 4a of a rectangular shape, and on the surface on one side thereof (upper surface in FIG. 4) are erected support members 4b, 4b of the shape of a flat plate at a predetermined distance. The support members 4b, 4b are respectively provided with bosses 4c, 4d. The respective bosses 4c, 4c have bearing holes 4e formed on the same axis X1, and the respective bosses 4d, 4d have bearing holes 4f formed on the same axis X2. The axis X1 and the axis X2 are substantially in parallel with each other.

On the other surface of the base plate 4a (lower surface in FIG. 4) are erected a pair of flat hook plates 4g, 4g, at a predetermined distance, substantially in parallel with the above-mentioned pair of support members 4b, 4b. A hook member 7 is arranged between the pair of hook plates 4g, 4g at the ends thereof on the bearing holes 4e side. The hook member 7 is a round rod member in which is formed an engaging groove 6a having a U-shape in cross section and extending in the axial direction thereof. An opening of the engaging groove 6a faces toward the other end side of the hook plates 4g, and the engaging groove 6a extends in a direction substantially in parallel with the axis X1. At the respective ends, opposite to the fixed hook 6, of the hook plates 4g, 4g, there are provided arcuated guide portions 4h with the axis X2 of the bearing holes 4f as a center. The guide portions 4h are formed in a radius that meets the edge on the center side of the engaging groove 8a of swing of the movable hook 8 (the movable hook 8 will be described later) that is mounted to the bearing holes 4f of the bracket 4 so as to pivot on the axis X2.

On the surface of the base plate 4a on which the support members 4b, 4b are mounted, there are further provided a pair of bearing members 4k having bearing holes 4j for rotatably mounting an end of a swing-operation means 10 (the swing-operation means 10 will be described later in detail), at a predetermined distance, between the support members 4b and 4b.

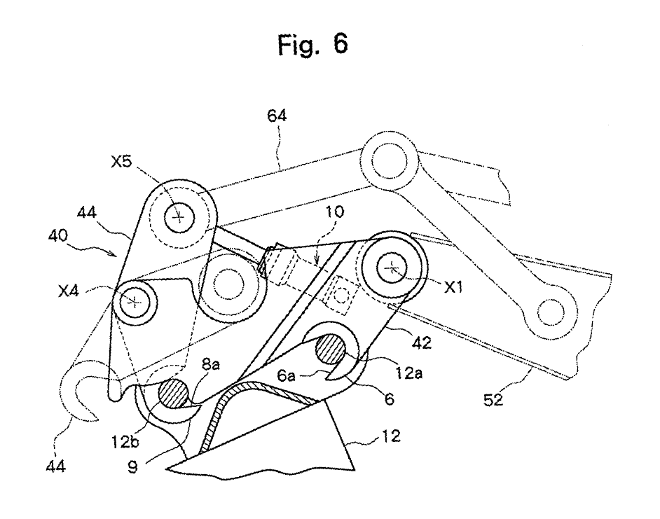

With reference to FIGS. 1 and 2 together with FIG. 5 and chiefly FIG. 5, the movable hook 8 is also formed as an integrated structure by welding various steel members each other. The movable hook 8 comprises a pair of hook plates 8b, 8b arranged at a predetermined distance, bosses 8c provided at one end of each of the hook plates and bearing holes 8d formed on the same axis X1. A hook member 9 is mounted between the other ends of the hook plates 8b, 8b. The hook member 9 is formed of a round rod member in which is formed an engaging groove 8a having a U-shape in cross section and extending in the axial direction. An opening of the engaging groove 8a faces toward the fixed hook 6 side in a state where the movable hook 8 is mounted on the bearing holes 4f, 4f of the bracket 4, and the engaging groove 8a extends substantially in parallel with the axis X1.

The distance between the outer sides of the hook plates 8b and 8b is so defined that they are allowed to freely swing in the pair of support members 4b, 4b of the bracket 4. The distance between the outer side surfaces of the pair of bosses 8c and 8c in the direction of axis X2 is so defined as to be incorporated between the inner side surfaces of the pair of bosses 4d and 4d.

Further, bearing holes 8e for attaching the other end of the swing-operation means 10 are formed on the same axis X3 at intermediate portions between the end where the bearing holes 8d are formed and the end where the hooking member 9 is provided of the respective hook plates 8b, 8b.

The movable hook 8 can be formed as an integrated structure also by casting.

The swing-operation means 10 shown in FIGS. 1 and 2 is constituted by an extensible and retractible double-acting fluid cylinder with its output rod 10a at one end being rotatably attached to a shaft member 14 mounted in the bearing holes 4j of the bracket 4 and a cylinder body 10b at the other end thereof being rotatably attached to a shaft member 16 mounted in the bearing holes 8e of the movable hook 8. The extending and retracting action of the fluid cylinder 10 is controlled as the operation fluid is supplied from the fluid control means in the body of the working machine through a pipe (not shown).

With reference to FIG. 1 and FIG. 3 and chiefly FIG. 3, the coupling shafts 12a and 12b are mounted by welding or by a suitable means between a pair of plates 12c and 12c arranged on the upper part of the bucket body substantially in parallel with each other. Between the coupling shafts 12a and 12b, there is positioned a torque tube 13 which is a structural member formed by bending a plate member in the form of a mountain in cross section.

With the thus constituted quick coupling device 2, the pair of support members 4b and 4b of the bracket 4 are rotatably mounted on the arm 52 and on the swing-operation link 64 respectively by inserting a shaft member (not shown) in the bearing holes 4e, 4e and by inserting a shaft member (not shown) in the bearing holes 4f, 4f. These shaft members are known ones that are used for directly attaching the working implement to the arm 52 and to the swing-operation link 64 without use of the quick coupler 2.

To couple the bucket 12 to the arm 52 via the quick coupler 2, the fluid cylinder 10 of the swing-operation means is extended by supplying the fluid to the head end thereof from the fluid control means, and the movable hook 8 is caused to swing in a direction (indicated by a two-dot chain line) to separate away from the fixed hook 6 thereby to expand the distance between the engaging groove 8a of the movable hook 8 and the engaging groove 6a of the fixed hook 6. Then, first, the one coupling shaft 12a of the bucket 12 is brought into engagement with the engaging groove 6a of the fixed hook 6. Thereafter, the coupling shaft 12b of the bucket 12 is first brought into contact with the guide portion 4h and then, the fluid cylinder 10 is caused to be retracted by supplying the fluid into the rod end thereof from the fluid control means. Then, the movable hook 8 is moved in a direction to approach the fixed hook 6 to bring the coupling shaft 12b into engagement with the engaging groove 8a. The supply of the fluid into the fluid cylinder 10 is, then, discontinued to maintain this state, whereby the bucket 12 is coupled to the arm 52 through the quick coupler 2.

To release the engagement, the fluid cylinder 10 is retracted to swing-operate the movable hook 8 in a direction to separate away from the fixed hook 6, thereby to release the coupling shaft 12b from the engaging groove 8a and to release the coupling shaft 12a from the engaging groove 6a.

The action of the above-mentioned quick coupler 2 will now be described with reference to FIGS. 1 to 3.

(1) Interference between the movable hook and the working implement:

At the time of coupling the bucket 12 which is a working implement to the arm 52 via the quick coupler 2, i.e., at the time of moving the movable hook 8 toward the fixed hook 6 side, the movable hook 8 is caused to swing inward from the outer side (indicated by a two-dot chain line in FIG. 1) of the bucket 12 separated away from the fixed hook 6 and is brought into engagement with the coupling shaft 12b (a state indicated by solid lines in FIG. 1). Therefore, irrespective of the presence of the torque tube 13 which is the structural member of the bucket 12 between the coupling shafts 12a and 12b, the movable hook 8 does not interfere with the structural member 13. Thus, since the movable hook 8 swings on the outside of the coupling shafts 12a and 12b, it does not interfere with the structural member 13 between the coupling shafts 12a and 12b and further, no limitation is imposed by the quick coupler 2 on the number of the working implements that can be mounted, i.e., it is allowed to increase the number of the working implements that can be mounted.

(2) Damage to the coupling shafts of the working implement:

In a state where the bucket 12 is coupled to the arm 52 via the quick coupler 2, the opening of the engaging groove 8a of the movable hook 8 and the opening of the engaging groove 6a of the fixed hook 6 face each other, i.e., face inward of the bucket 12. Therefore, foreign matters such as earth and sand are prevented from coming into direct contact with the coupling shafts 12a and 12b from the outside during the operation, and the coupling shafts 12a and 12b are prevented from being damaged.

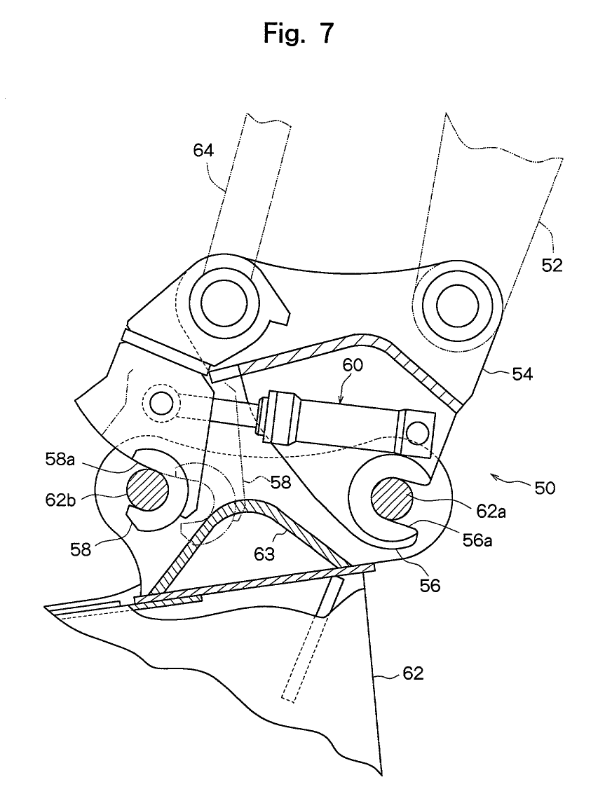

Another embodiment of the quick coupling device of the present invention will be described with reference to FIG. 6. The quick coupler which is generally designated at 40 is the one in which the swinging center X2 of the movable hook 8, the position X3 for mounting the movable hook 8 and the swing-operation means 10 and the position X2 for mounting the swing operation link 64 are changed in the embodiment of the above quick coupling device 2 (FIG. 1). Therefore, the portions substantially the same as those of the quick coupling device 2 shown in FIGS. 1 to 5 are denoted by the same reference numerals but are not described again.

The quick coupler 40 comprises the bracket 42 mounted on the end of the arm 52 of the working machine so as to pivot on the axis X1, the fixed hook 6 that has the engaging groove 6a formed therein and is secured to the bracket 42, the movable hook 44 having the hook member 9 in which the engaging groove 8a is formed, the movable hook 44 being mounted on the bracket 42 so as to pivot on the axis X4, the extensible and retractible swing-operation means 10 disposed between the movable hook 44 and the bracket 4, and the pair of coupling shafts 12a and 12b provided in the bucket 12 as a working implement, the pair of coupling shafts 12a and 12b being detachably engaged with the engaging grooves 6a and 8a.

The movable hook 44 has the swing-operation means 10 that is rotatably mounted to one end portion thereof so as to pivot on the axis X5, has the engaging groove Ba formed in the other end portion thereof, and its intermediate portion is mounted to the bracket 42 so as to rotate about the axis X4. The swing-operation link 64 for swing-operating the bracket 42 is rotatably coupled to the movable hook 44 on the same axis X5 as the center of rotation of the swing-operation means 10 to which the movable hook 44 is coupled.

In addition to the solution of the problems of “interference between the movable hook and the structural member of the working implement” and “damage to the coupling shafts of the working implement”, which are effects brought about by the action of the quick coupling device 2 described above, the thus constituted quick coupling device 40 permits the movable hook 44 to be held by both the swing-operation means 10 and the swing-operation link 64 as a result of the swing-operation link 64 being coupled to the movable hook 44. Even in carrying out the task which exerts a large load on the working implement 12, therefore, the quick coupler 40 of this embodiment can reliably hold the coupling shafts 12a and 12b of the working implement 12. Accordingly, it is also possible to downsize the size of the fluid cylinder in the swing-operation means 10.

Though the present invention was described above in detail by way of the embodiments, it should be noted that the invention is in no way limited to the above embodiments only but can be varied or modified in a variety of ways within the range and scope of the invention.

In the embodiments of the invention, for example, the swing-operation means 10 is constituted by an extensible and retractible double-acting fluid cylinder. The swing-operation means 10, however, may be a mechanical extensible/retractible means such as screw bolts or a turnbuckle constituted by a right-hand screw and a left-hand screw.

According to the quick coupling device for a working machine constituted according to the present invention, there is provided a quick coupling device for a working machine, in which a working implement is detach- and attachably coupled to a bracket mounted on the working machine by a pair of coupling shafts and a pair of hooks having an engaging groove detachably engaged with the coupling shafts, wherein it is so designed that the hooks are prevented from interfering with the structural member of the working implement provided between the pair of coupling shafts and foreign matters such as earth and sand are prevented from coming into direct contact with the coupling shafts.

1. A quick coupling device for a working machine, in which a working implement is detach- and attachably coupled to a bracket mounted on the working machine by a pair of coupling shafts and a pair of hooks detachably engaged with the coupling shafts, wherein said pair of hooks are brought close to each other to bring said hooks into engagement with said coupling shafts.

2. The quick coupling device for a working machine according to claim 1, wherein said pair of hooks have respectively an engaging groove formed therein and comprise a fixed hook secured to said bracket and a movable hook swingably mounted on said bracket, said pair of coupling shafts are provided for said working implement, and an extensible and retractible swing-operation means is arranged between said movable hook and said bracket; and
each of said engaging grooves have each a U-shape in cross section and its opening faces the direction in which said movable hook swings, said movable hook is caused to swing in a direction to approach said fixed hook by said swing-operation means so that said engaging grooves are brought into engagement with said coupling shafts respectively, and said movable hook is caused to swing in a direction to separate away from said fixed hook by said swing-operation means so as to release the engagement.

3. The quick coupling device for a working machine according to claim 2, wherein said movable hook is mounted onto said bracket at its one end, has said engaging groove formed in the other end thereof, and has said swing-operation means rotatably coupled thereto at an intermediate portion thereof.

4. The quick coupling device for a working machine according to claim 2, wherein said movable hook has said engaging groove formed in one end thereof, has said swing-operation means rotatably coupled to the other end thereof, and is mounted onto said bracket at the intermediate portion thereof, said bracket being swingably coupled to said working machine, and a swing-operation link for swing-operating said bracket is coupled to the portion of said movable hook, to which said swing-operation means is coupled, so as to rotate on the same axis.
